(19) United States
(12) Patent Application Publication
(10) Pub. No.: US 2001/0030020 A1
(43) Pub. Date: Oct. 18, 2001

(54) CLEAR AND OPAQUE LABELS AND METHODS AND SYSTEMS FOR PRODUCING CLEAR OR OPAQUE LABEL STOCK LAMINATED WITH PRESSURE-SENSITIVE ADHESIVE

(76) Inventors: SUBHASHIS NANDY, MT. LAUREL, NJ (US); ULRICH E. WEYERMANN, BETHANY BEACH, DE (US); DANIEL B. CHAFFEE, LEVITTOWN, PA (US)

Correspondence Address: JANE MASSEY LICATA, LAW OFFICES OF JANE MASSEY LICATA, 66 E MAIN STREET, MARLTON, NJ, 08053

(21) Appl. No.: 09/282,642

(22) Filed: Mar. 31, 1999

Related U.S. Application Data
(60) Provisional application No. 60/083,435, filed on Apr. 29, 1998.
(60) Provisional application No. 60/106,564, filed on Nov. 2, 1998.

(51) Int. Cl. C09J 1/00

(52) U.S. Cl. 156/289; 156/543; 156/555

(57) ABSTRACT

Methods and systems for producing continuous laminated film label stock from a polypropylene or polyethylene film with pressure-sensitive adhesives which cure without evaporation by heating and labels produced by these methods are provided.

### BACKGROUND OF THE INVENTION

Polypropylene and polyethylene films are commonly used for container labels, particularly for labels on plastic containers such as shampoo bottles. Labels produced from polypropylene or polyethylene films are desirable because they are clear and extremely thin films, thus providing a look that is similar to silk-screening on the surface at a much lower cost. The polypropylene or polyethylene labels impart a clear, no label appearance to the plastic bottle. Polypropylene and polyethylene labels typically have a thickness of approximately 2 mils. Accordingly, these materials become easily deformed, and thus must be laminated onto a substrate material such as a polyester liner.

This lamination is most often performed by applying a solvent-based or water-based, pressure-sensitive adhesive onto a polyester liner. A release layer, generally comprising silicone, is first applied to a surface of the polyester liner to form what is referred to as a polyester release liner. The presence of the release layer prevents the adhesive from forming a permanent bond with the surface of the polyester liner. The adhesive is then applied onto the release layer of the polyester release liner. The adhesive is then dried or “cured” by transporting the polyester release liner through a long oven to evaporate excess water or solvent. After completion of drying of the adhesive, the polyester release liner and the polypropylene or polyethylene film are pressed together, as by two pressing rolls or nip rolls, to form a laminate. The laminated product is then typically delivered to a printer. The top surface of the polypropylene label is printed with the appropriate images. The polypropylene or polyethylene layer of the laminate is then die cut to the shapes of individual labels, and the excess polypropylene or polyethylene material is removed, leaving only the printed labels on the polyester release liner. The printed labels on the polyester release liner are then shipped to a packaging facility, wherein the labels are removed from the polyester release liner and applied to the surfaces of containers. The pressure-sensitive adhesive serves to secure the labels to the surfaces of the containers.

For example, U.S. Pat. No. 4,849,043 discloses a method of producing a succession of self adhesive labels on a backing of release material. This method involves cutting a laminar material which comprises a web which has been coated on its reverse side with a pressure-sensitive adhesive and having a backing of a release material, the cutting being performed in such a manner that all the layers of the laminar material other than the backing layer are cut so as to produce a succession of spaced label base portions on the backing. An adhesive is then applied at least to an area within each label base portion and waste portions of the web outside the label base portions are removed. Individual preprinted folded labels are then successively applied to cover the respective base portions which have been coated with adhesive.

However, use of solvent-based or water-based, pressure-sensitive adhesives to produce the polypropylene or polyethylene labels has its own disadvantages. Specifically, because the film is transported at a high speed, the drying ovens must be very large so that the adhesive is exposed to heat for a sufficiently long period of time to remove the excess water or solvent from the adhesive. The oven therefore, occupies a large amount of valuable floor space at facilities for production of these items. Further, the solvents used in such solvent-based, pressure-sensitive adhesives are often toxic and flammable, thus resulting in a need for extensive measures to prevent the release of solvent vapors into the environment. Thus, special arrangements must be made to collect solvent vapors exiting the oven so that they do not escape into the environment.

Accordingly, various methods for producing labels using hot-melt adhesives such as those described in U.S. Pat. No. 5,421,941 which cure to the polyester release liner by cooling, rather than heating, of the adhesive have been described.

U.S. Pat. No. 5,584,955 discloses a method for producing self-adhesive labels by application of a succession of patches of pressure-sensitive adhesive from a coating head to the surface of a length of silicone coated release material, being either paper or plastic, followed by application of a succession of individual labels which are fed from a label feed device with a conveyor belt to the patches of pressure-sensitive adhesive so that each label is adhered to the release material by a respective patch of adhesive. The pressure-sensitive adhesive may be either a water-based pressure-sensitive adhesive, a hot-melt pressure-sensitive adhesive or a solvent-based pressure-sensitive adhesive. The patches of pressure-sensitive adhesive are applied to the surface of a length of release material either via an extruder which is adapted to extrude a series of parallel adhesive beads of a predetermined length, a dot-matrix applicator which is adapted to apply an array of dots of adhesive of predetermined shape and dimensions or by printing. The individual labels may be lithographically printed sheets or folded sheets. Advantages taught for this method over prior art methods are that it enables individual labels to be releasably adhered to a release web, for subsequent application to containers to be labeled, without any removal of excess adhesive or label portions. Further, this method is taught to obviate the need for a self-adhesive support web.

U.S. Pat. No. 5,092,949 discloses a method of using hot-melt adhesives to produce a laminated, thermally imageable tag, such as a baggage tag, from a top sheet. In this method, a top sheet is precoated on one surface with a thermally sensitive material. A hot-melt adhesive is applied to a bottom sheet. The top sheet, reinforcing fibers, and the bottom sheet are then pressed together, as by two pressing rolls defining a nip. A laminate is thus formed with the reinforcing fibers between the top and bottom sheets.

In the present invention, there is provided an improved method and system for producing continuous label laminate material. This method involves application of a continuous film of pressure-sensitive adhesive in a lengthwise direction onto a release liner, which is then transfer coated via pressure onto a transparent or opaque and colored polypropylene or polyethylene film. In this method, decorative label images can be printed on either the front or back surface of transparent polypropylene or polyethylene film or the front surface of opaque polypropylene or polyethylene film. Individual labels are then die cut on the polypropylene or polyethylene face stock which remain adhered to the release liner. These labels are dispensed onto bottles either later at a manufacturing facility or immediately in a production line linked to a system of the present invention. Of course, the continuous polypropylene or polyethylene sheet laminated to a release liner with a pressure sensitive adhesive can also be used as a label stock in other applications.

### SUMMARY OF THE INVENTION

An object of the present invention is to provide a method for making continuous laminated film label stock comprising a polypropylene or polyethylene film as the top material, a pressure-sensitive adhesive as the middle layer and a release liner which serves as the bottom material of the laminate. In this method, the laminated film label stock is prepared by applying a pressure-sensitive adhesive which cures without evaporation via heat, i.e. hot-melt or an ultraviolet or electron-beam radiation curable adhesive, through a slot die head onto a release liner. Use of a pressure-sensitive adhesive which is cured without evaporation via heat eliminates the need for large drying ovens and means for collecting toxic solvent vapors released during curing of solvent-based adhesives. The adhesive layer is then transfer coated from the release liner onto a polypropylene or polyethylene film having a front and back surface by pressing the back surface of the film against the adhesive coated surface of the release liner so that the adhesive on the release liner surface is transfer coated onto the back surface sheet and the front surface of the polyethylene or polypropylene film remains free from contact with the pressure-sensitive adhesive. Accordingly, in this method, decorative images for labels can be pre-printed on either the front or back surface of transparent polypropylene or polyethylene film or printed on the front surface of opaque polypropylene or polyethylene film or the laminated film label stock. Individual labels are then die cut into the laminated polypropylene or polyethylene film layer and pressure-sensitive adhesive layer and remain adhered to the release liner until use.

Another object of the present invention is to provide polypropylene or polyethylene labels prepared in accordance with this method, wherein the labels comprise a liner with a release layer, a layer of pressure-sensitive adhesive cured without evaporation by heat and a polyethylene or polypropylene film layer.

Yet another object of the present invention is to provide a system for producing polypropylene or polyethylene labels which comprises a reservoir for holding a pressure-sensitive adhesive which is cured without evaporation via heat; a means for pumping the pressure-sensitive adhesive to a slot die head connected to said reservoir; a slot die head which evenly distributes the pressure-sensitive adhesive pumped from the reservoir onto a polyester release liner; a first unwind station for feeding the polyester release liner through the slot die head; a backup roll positioned adjacent to said slot die head; a means for positioning said slot die head relative to said backup roll so that a uniform layer of pressure-sensitive adhesive is applied through said slot die head onto the polyester release liner on said backup roll; a means for transfer coating the uniform layer of pressure-sensitive adhesive onto a polypropylene or polyethylene film; and a second unwind station for feeding the polypropylene or polyethylene film into the transfer coating means.

### BRIEF DESCRIPTION OF THE DRAWINGS

FIG. 1 provides a schematic drawing of a preferred embodiment of a system for production of polypropylene or polyethylene labels of the present invention.

FIG. 2 provides a cross-sectional view of a label produced in accordance with the method of the present invention.

### DETAILED DESCRIPTION OF THE INVENTION

The present invention relates to a new method and system for making continuous laminated film label stock from polypropylene or polyethylene films. Polypropylene or polyethylene films useful in the present invention may be transparent or opaque and colored. In the method of the present invention, a pressure-sensitive adhesive which cures without the need for evaporation by heat is applied via a slot die head to a continuous surface of a release liner provided in a lengthwise direction. Examples of pressure-sensitive adhesives which cure without the need for evaporation by heat include, but are not limited to, hot-melt pressure-sensitive adhesives, ultraviolet-ray curable pressure-sensitive adhesives and electron beam radiation curable pressure-sensitive adhesives. It is preferred that the release liner comprises a layer of polyester of a thickness capable of withstanding the heat of the molten adhesive but which is easy to dispose of during label application coated with a release layer such as silicone. Clear polyester layers of approximately 1.5 mil in thickness are preferred. However, alternative materials having similar properties, such as paper for the liner and wax for the release liner may also be used. Release liners useful in the present invention will typically range in width from 7 to 15 inches. However, as will be obvious to those of skill in the art upon this disclosure, the method and system of the present invention can be easily modified to be used with release liners of any width.

A continuously fed polypropylene or polyethylene film having a front and back surface is then pressed against the adhesive coated surface of the release liner so that the adhesive on the release liner is transfer coated onto the back surface of the polypropylene or polyethylene film. The front surface of the polyethylene or polypropylene thus remains free from contact with the pressure-sensitive adhesive. The thickness of the film is selected to be able to withstand the heat of the molten adhesive while dispensing easily during the label application stage. In a preferred embodiment, the polypropylene or polyethylene film is approximately 2 mil in thickness. The width of the film is preferably equal to the width of the release liner and typically ranges in width from 7 to 15 inches. However, as will be obvious to those of skill in the art upon this disclosure, the method and system of the present invention can be easily modified to be used with films of any width. The polypropylene or polyethylene film may be preprinted before it is laminated to the release liner and adhesive. In this case, it is preferred that the preprinting be done on the back surface of a transparent polypropylene or polyethylene film. In this embodiment, a special coating such as an acrylate-based high surface energy coating may be placed on the back surface of the polyethylene or polypropylene film to help in anchorage of the printing inks. Since the adhesive layer is transfer coated onto the back surface of the polypropylene or polyethylene film, in this embodiment the ink will be protected, both during the transportation of the label from the pressing means to application on the container and after application to the container. Preprinting on the back surface of transparent polyethylene or polypropylene film thus results in significantly fewer damaged labels before the container reaches the consumer. Alternatively, the printing may be performed on the front surface of transparent or opaque and colored polypropylene or polyethylene film prior to or following preparation of laminated film stock. For printing on the front surface of the film after preparation of the laminated film stock, it is again preferred that the polypropylene or polyethylene film have a acrylate-based high surface energy coating on the front surface which assists in anchorage of the printing inks and helps in printing of decorative labels.

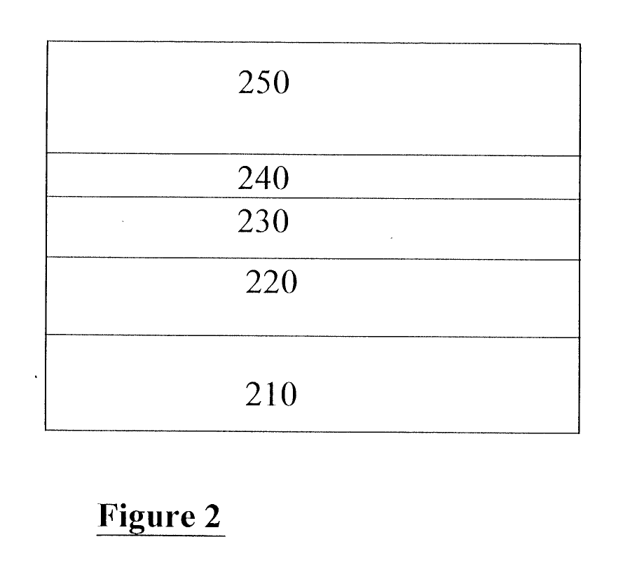

A cross-sectional view of a preprinted film stock laminate produced by the method of the present invention is depicted in FIG. 2. In this Figure, the bottom layer, also referred to herein as a release liner comprises a liner 210 having a release layer 220. In a preferred embodiment, the liner 210 comprises a clear layer of polyester and the release layer 220 comprises silicone. However, other appropriate materials for the release liner such as wax paper are also routinely used in the art. The next layer of the laminate comprises a pressure-sensitive adhesive 230. Pressure-sensitive adhesives useful in the present invention are thermoplastic polymers which do not require evaporation by heat for curing and which are useful in securing the labels to the container surface under application of mild and even pressure on the top surface of the label. Examples of useful pressure-sensitive adhesives include, but are not limited to, hot-melt pressure-sensitive adhesives, ultraviolet-ray curable pressure-sensitive adhesives and electron beam radiation curable pressure-sensitive adhesives. All of these adhesives do not require evaporation by heat for curing. Thus, use of these types of pressure-sensitive adhesives eliminates the need for large ovens required for curing of water-based and solvent-based pressure-sensitive adhesives and means for collecting toxic solvent vapors released during curing of solvent-based adhesives. The top layer of the laminate of FIG. 2 is the polyethylene or polypropylene film or label 250. Also depicted in FIG. 2 is layer of ink 240 which is on the back surface of the polyethylene of polypropylene film in embodiments wherein the film is transparent and preprinted prior to production of the laminate.

Also provided in the present invention are systems for producing polypropylene or polyethylene labels having polyester release liners. This system is capable of coating pressure-sensitive adhesives cured without evaporation via heat onto polyester release liners without any defects. More specifically the adhesive is applied streak free. Systems of the present invention comprise a reservoir for holding a pressure-sensitive adhesive which is cured without evaporation via heat. For hot-melt pressure-sensitive adhesives, it is preferred that this reservoir be heated to an appropriate temperature which maintains the adhesive in a molten state. The reservoir is associated with a means for pumping the pressure-sensitive adhesive to a slot die head connected to the reservoir. In a preferred embodiment, the pumping means comprises a gear pump as it has the ability to accurately control the flow rates of the adhesive. When using a hot-melt adhesive, it is preferred that both the hose and the slot die head also be heated to a temperature which maintains the adhesive in a molten state.

Slot die heads are well known to those of skill in the art. A slot die head comprises an opening defined by two lips which are maintained at a selected distance from one another via a means such as a metal shim positioned between the two lips. The distance between the two lips of the slot die head is selected to obtain an optimal flow of the adhesive onto a release liner which is fed from a first unwind station through the slot die head and pulled at a selected line speed via a back up roll. The length of the lips of the slot die head is preferably selected to be equal to the width of the lengthwise positioned release liner and the polypropylene or polyethylene film.

The back up roll is positioned adjacent to the slot die head and pulls a continuous, preferably clear, polyester release liner at an appropriate line speed, preferably 100 to 300 feet per minute, from a source and over the back up roll so that the release liner is in close proximity to the lips of the slot die head. When using hot-melt adhesives, it is preferred that the back up roll be chilled to remove the heat from the release liner so that the temperature of the release liner is increased as little as possible thereby preventing distortion of the release liner. Chilling of the back up roll also serves to cool the hot-melt adhesive layer so that it cures quickly to a solid layer.

Positioning of the slot die head with respect to the release liner and back up roll is controlled through a positioning means which permits fine adjustments of the relative positions of the slot die head with respect to the back up roll. For example, said positioning means may comprise two sets of position adjustment screws, one for coarse movement of the die, and the other for fine movement of the die. The opening of the slot die head is preferably positioned at a distance from the surface of the back up roll and at an angle from the horizontal plane of the release liner so that a uniform layer, preferably between 1 and 1.2 mil, of pressure-sensitive adhesive is evenly or uniformly distributed on the release liner. The two lips of the slot die head remain parallel to the surface of the back up roll.

A polypropylene or polyethylene film is fed from a second unwind station to a means for transfer coating the adhesive layer on the polyester release liner via pressing onto the polypropylene or polyethylene film. In one embodiment, the polypropylene or polyethylene film is fed over an idler roll and rubber nip roll to a nip point intermediate positioned between the back up roll and the rubber nip roll so that the back surface of the polypropylene or polyethylene film is pressed against the pressure-sensitive adhesive layer applied on the release liner at a selected lamination pressure so that the adhesive layer is transfer coated onto the back surface of the polypropylene or polyethylene film. In a preferred embodiment the lamination pressure at the nip point is maintained at approximately 30 to 40 pounds per square inch. This method and system produces a clear and defect free coating of the adhesive on the polyethylene of polypropylene film. By clear and defect free coating, it is meant that the pressure-sensitive adhesive is transfer coated onto the polypropylene or polyethylene film very smoothly without any wetting defect, and without any streak.

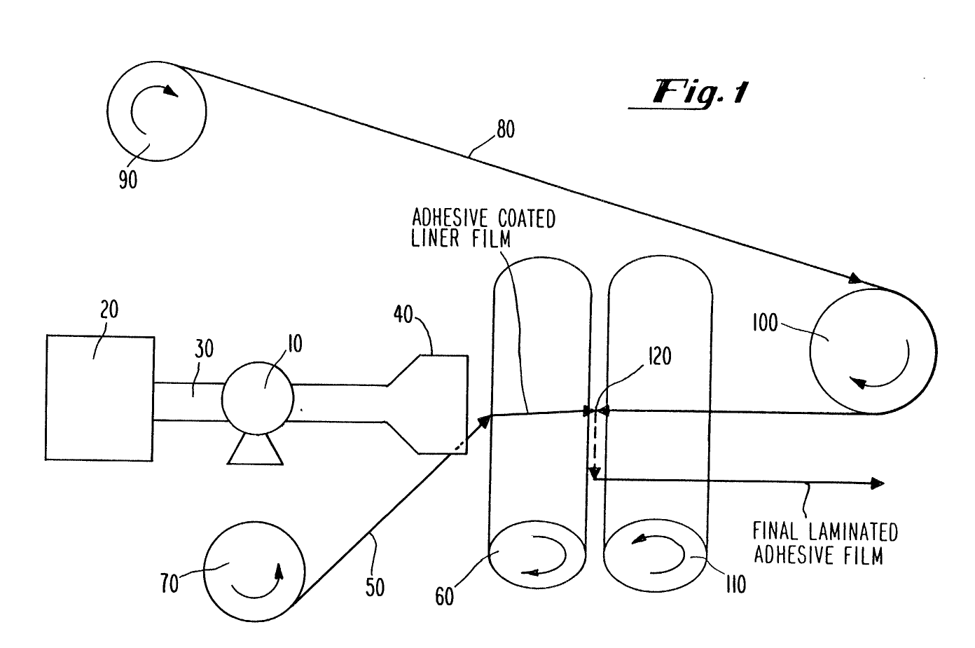

A preferred embodiment for a system of the present invention which transfer coats a hot-melt pressure-sensitive adhesive from a polyester release liner onto a polyethylene or polypropylene film to produce a laminate stock film for subsequent printing of labels is depicted in FIG. 1. The system comprises a gear pump 10 which pumps the hot-melt pressure-sensitive adhesive from a reservoir 20 through a hose 30 to slot die head 40. In this embodiment, the reservoir 20, hose 30 and slot die head 40 are heated and maintained at a temperature which keeps the hot-melt adhesive in a molten state, i.e. 340 to 350° F. In this embodiment, the distance between the lips of the slot die head 40 is approximately 10 mil and the length is approximately 15 inches to accommodate a 15 inch wide polyester release liner and polypropylene or polyethylene film. A release liner 50 is pulled at a line speed of approximately 150 feet per minute from a source over a back up roll 60. The back up roll 60 is positioned adjacent to the slot die head 40 so that the release liner 50 is in close proximity to the lips of the slot die head 40. In this embodiment, the backup roll 60 is chilled to 10° F. by flowing coolant through the back up roll 60 to remove any heat from the release liner 50 so that the temperature of the release liner is increased as little as possible to prevent distortion of the release liner. The chilled backup roll 60 also serves to cool the hot-melt adhesive layer so that it cures to a solid layer. In this embodiment, the opening of the slot die head 40 is positioned at a distance of approximately 3 mil from the surface of the back up roll 60. Further, the plane on which the two lips of the slot die head is adjusted to an angle of 3.5 degrees from the horizontal plane of the release liner 50. The two lips of the slot die head 40 are positioned parallel to the surface of the chilled back up roll 60. This position of the slot die head 40 makes it possible to deposit a uniform 1 mil thick layer of molten hot-melt pressure-sensitive adhesive on a release liner 50 fed from a first unwind station 70 through the slot die head 40 having an opening of 10 mil by 15 inches, with an adhesive flow rate of 1 pound per minute. A polypropylene or polyethylene film 80 which is 15 inches wide is fed from a second unwind station 90, over an idler roll 100, and over a rubber nip roll 110 to a nip point 120 intermediate between the chilled back up roll 60 and the rubber nip roll 110. At the nip point 120, the pressure-sensitive adhesive layer applied on the polyester release liner 50 is transfer coated onto the back surface of a polypropylene or polyethylene film 80. The lamination pressure at the nip point 120 is preferably maintained at 30 pounds per square inch.

The following nonlimiting examples are provided to further illustrate the present invention.

### EXAMPLES

### Example 1

### Production of a Film Stock Laminate with a Hot-melt Adhesive

A hot-melt pressure-sensitive adhesive, 82274 (Reichold Chemicals) was applied to a 15-inch wide 1.5 mil clear polyester liner with a silicone release layer. The adhesive was extruded through a slot die head maintained at 350° F. via electrical current at a rate of 1 pound per minute. A chilled back up roll maintained at a temperature of 10° F. was also used. The adhesive layer was transfer coated to a polypropylene film, 2.0 mil in thickness, at a lamination pressure of 30 pounds per square inch. The line speed was 150 feet per minute.

### Example 2

### Peel Adhesion Testing

The film resulting from the process of Example 1 was tested for peel adhesion. Peel adhesion is the force per unit width required to break the bond between the pressure-sensitive adhesive film and a stainless steel surface when peeled back at a 90-degree angle at the rate of 12 inches per minute. This measured property helps in determining the adhesive strength of the film for satisfactory performance. This property is also important in determining the uniformity of quality of the adhesive. The average of 8 film samples in this peel adhesion test was 2.5 pounds per inch. The expected range of 90-degree peel value for this particular label application is between 2 and 3 pounds per inch.

### Example 3

### Quick Stick Properties

The quick stick property of the adhesive-coated film produced in Example 1 was also determined. This property causes the adhesive film to adhere to a surface instantly, using no external pressure to secure more thorough contact. It is measured as the force resisting peeling of the film at a 90 degree angle from a stainless steel surface upon which it has been applied under no pressure other than the weight of the film itself. Quick stick is thus a measure of the adhesive's ability to adhere with a minimum pressure. For 8 film samples tested, the average results of this test were 1.2 pounds per inch. the expected range of quick stick values for this particular label application is between 1 and 2 pounds per inch.

### Example 4

### Holding Power

The holding power of the adhesive film produced in Example 1 was also evaluated. The holding power is the ability of the adhesive film to remain adhered under a load applied parallel to the surface of the film. In this test, an area of one square inch of the film was applied to a vertical stainless steel surface; a mass of one kilogram was applied parallel to the adhesive film surface, and allowed to act until failure at room temperature. For 8 film samples tested, the average time to failure of the adhesive film from the test was 34 hours. The time to failure of the film under the standard load gives an estimate of the holding power of the tape. The expected range of holding power for this type of label is between 24 and 48 hours.

What is claimed is:

1. A method of making continuous laminated film label stock from a polypropylene or polyethylene film comprising:
(a) providing a continuous release liner lengthwise;
(b) applying via a slot die head a pressure-sensitive adhesive cured without evaporation by heat to the release liner; and
(c) pressing a continuously fed polypropylene or polyethylene film having a front and back surface against the adhesive coated surface of the release liner so that the adhesive on the release liner is transfer coated onto the back surface of the polyethylene or polypropylene film and the front surface of the polyethylene or polypropylene film remains free from contact with the pressure-sensitive adhesive.

2. A polyethylene or polypropylene label comprising a release liner, an adhesive layer and a polypropylene or polyethylene film produced in accordance with the method of claim 1.

3. A system for producing polypropylene or polyethylene labels with polyester release liners comprising:
(a) a reservoir for holding a pressure-sensitive adhesive which is cured without evaporation by heat;
(b) a means for pumping the pressure-sensitive adhesive to a slot die head connected to said reservoir;
(c) a slot die head which distributes the pressure-sensitive adhesive pumped onto a polyester release liner;
(d) a first unwind station for feeding the polyester release liner through the slot die head;
(e) a backup roll positioned adjacent to said slot die head;
(f) a means for positioning said slot die head relative to said backup roll so that a uniform layer of pressure-sensitive adhesive is applied through said slot die head onto the polyester release liner on said backup roll;
(g) a means for transfer coating the uniform layer of pressure-sensitive adhesive onto a polypropylene or polyethylene film; and
(h) a second unwind station for feeding the polypropylene or polyethylene film into the transfer coating means.
